(19) United States
(12) Patent Application Publication
(10) Pub. No.: US 2014/0104849 A1
(43) Pub. Date: Apr. 17, 2014

(54) LAMP

(71) Applicant: OSRAM GmbH, Muenchen (DE)

(72) Inventors: Oliver Woisetschlaeger, Sontheim (DE); Peter Helbig, Sontheim/Brenz (DE); Peter Niedermeier, Muenchen (DE)

(73) Assignee: OSRAM GmbH, Muenchen (DE)

(21) Appl. No.: 14/050,388

(22) Filed: Oct. 10, 2013

(30) Foreign Application Priority Data
Oct. 16, 2012 (DE) 102012218785.5

(51) Int. Cl. F21K 99/00

(52) U.S. Cl. CPC F21K 9/52
USPC 362/311.01

(57) ABSTRACT

In various embodiments, a lamp may include a lamp bulb composed of light-transmissive material; and at least one semiconductor light source arranged within the lamp bulb, and comprising a base, corresponding to a standardized incandescent lamp base; wherein the lamp has at least one optical waveguide which is connected to the lamp bulb and extends in the direction of the at least one semiconductor light source.

### CROSS-REFERENCE TO RELATED APPLICATION

This application claims priority to German Patent Application Serial No. 10 2012 218 785.5, which was filed Oct. 16, 2012, and is incorporated herein by reference in its entirety.

### TECHNICAL FIELD

Various embodiments relate generally to a lamp.

### BACKGROUND

A lamp of this type is disclosed for example in the German Utility Model specification DE 20 2011 100 723 U1. Said specification describes a lamp including a lamp bulb composed of light-transmissive material and at least one semiconductor light source arranged within the lamp bulb, and including a base provided with electrical connections and corresponding to a standardized incandescent lamp base.

Lamps of this type serve as a replacement for incandescent lamps. However, their light distribution does not satisfy the legal regulations for use as exterior lighting in motor vehicles. In particular, said lamps do not satisfy the regulations of the ECE (Economic Commission for Europe). Therefore, they can only be used for other purposes, for example as lighting in the interior of a motor vehicle.

### SUMMARY

In various embodiments, a lamp may include a lamp bulb composed of light-transmissive material; and at least one semiconductor light source arranged within the lamp bulb, and comprising a base, corresponding to a standardized incandescent lamp base; wherein the lamp has at least one optical waveguide which is connected to the lamp bulb and extends in the direction of the at least one semiconductor light source.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a side view of a lamp in accordance with various embodiments in schematic illustration;

FIG. 2 shows a side view of a lamp in accordance with various embodiments in schematic illustration;

FIG. 3 shows a side view of a lamp in accordance with various embodiments in schematic illustration;

FIG. 4 shows a side view of a lamp in accordance with various embodiments in schematic illustration;

FIG. 5 shows a side view of a lamp in accordance with various embodiments in schematic illustration;

FIG. 6 shows a side view of a lamp in accordance with various embodiments in schematic illustration;

FIG. 7 shows a side view of a lamp in accordance with various embodiments in schematic illustration; and

FIG. 8 shows a side view of a lamp in accordance with various embodiments in schematic illustration.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

Various embodiments provide a lamp which can be used as a replacement for an incandescent lamp in a corresponding holder and the light distribution of which corresponds to the legal regulations for use in luminaires fitted to the exterior of a motor vehicle.

The lamp according to various embodiments has a lamp bulb composed of light-transmissive material and at least one semiconductor light source arranged within the lamp bulb, and has a base corresponding to a standardized incandescent lamp base. According to various embodiments, the lamp has at least one optical waveguide which is connected to the lamp vessel and extends in the direction of the at least one semiconductor light source. With the aid of the optical waveguide, the light distribution of the light emitted by the at least one semiconductor light source is altered in such a way that the light distribution of the light emitted by the lamp according to various embodiments satisfies the legal regulations for use in luminaires fitted to the exterior of a motor vehicle. By virtue of the fact that the optical waveguide is connected to the lamp bulb and extends in the direction of the at least one semiconductor light source, the light from the at least one semiconductor light source is coupled into the optical waveguide and guided to the section of the lamp bulb which is connected to the optical waveguide.

Advantageously, the optical waveguide of the lamp according to various embodiments has an optical waveguide section arranged within the lamp bulb and embodied in a light-scattering fashion. As a result, in addition to the coupling-out of light at the ends of the optical waveguide, a further coupling-out of light is made possible in the region of the optical waveguide section embodied in a light-scattering fashion. Thus, by way of example, a more homogeneous illumination of the lamp bulb can be achieved or specific luminous centers can be set.

In accordance with various embodiments, the optical waveguide section embodied in a light-scattering fashion includes at least one truncated-cone-shaped section whose truncated cone lateral surface is provided with a groove structure or is embodied in a step-like or staircase-like fashion or is provided with microprisms. The abovementioned structure produces a light-scattering effect in a simple manner and allows light to be coupled out via the truncated cone lateral surface of the optical waveguide. Alternatively, however, it is also possible to provide other light coupling-out structures having a light-scattering effect at the surface of the at least one optical waveguide.

In accordance with various embodiments, the optical waveguide section embodied in a light-scattering fashion is provided with light-scattering particles or has a roughened surface. The light-scattering particles and the roughened surface likewise enable light to be coupled out via the lateral surface of the optical waveguide. The light-scattering particles can be arranged for example in the material of the optical waveguide or on the surface of the optical waveguide. Light-scattering particles used can be phosphor particles, for example, which convert part of the light emitted by the at least one semiconductor light source into light having a different wavelength. Said phosphor particles can be included in the material of the optical waveguide or arranged on the surface of the optical waveguide. As an alternative to light-scattering particles, small cavities, in particular laser-produced blisters within the optical waveguide can also serve for generating the light-scattering effect.

Advantageously, a first end of the optical waveguide of the lamp according to various embodiments terminates with a light-emitting surface of the at least one semiconductor light source in order to ensure that light is coupled into the optical waveguide as efficiently as possible. The semiconductor light source may consist of one or a plurality of semiconductor chips emitting electromagnetic radiation. A phosphor layer that converts electromagnetic radiation can be disposed in front of the semiconductor chips. A primary optical unit can be disposed in front of the semiconductor chips or the semiconductor chip surfaces or the phosphor converting layers, or the phosphor can be incorporated into a primary optical unit. The possible arrangements are comprehensively described here by the term light-emitting diode. An immersion medium for better coupling-in of light can be introduced between optical waveguide and light-emitting diode.

In accordance with various embodiments, a first end of the optical waveguide of the lamp according to various embodiments faces the at least one semiconductor light source and is embodied in a conical or truncated-cone-shaped fashion. By virtue of this shape, light from a plurality of semiconductor light sources, arranged in a ring-shaped manner, for example, can be coupled into the optical waveguide via the lateral surface of the conical or truncated-cone-shaped first end facing the semiconductor light sources. In various embodiments, the first, conical or truncated-cone-shaped end of the optical waveguide is embodied in a light-scattering fashion in order to enable a better illumination of the lamp bulb and a light distribution that is adapted to the light distribution of a comparable incandescent lamp.

Advantageously, a second end of the optical waveguide of the lamp according to various embodiments is connected to the lamp bulb in order to guide light from the at least one semiconductor light source to a specific section of the lamp bulb in a targeted manner. As a result, specific regions of the lamp bulb, for example a dome or a central section of the lamp bulb, can be illuminated in a targeted manner.

The lamp bulb advantageously has a conical surface structure in the region of connection to the optical waveguide, in order to enable a more homogeneous light emission in different directions. In various embodiments, a dome of the lamp bulb is provided as the region of connection to the optical waveguide and is provided with a conical surface structure in order to enable a more homogeneous light emission via the dome of the lamp bulb. In the region of the conical surface of the dome, it is possible to provide light-scattering structures such as, for example, convex or concave bulges in the conical surface.

The optical waveguide of the lamp according to various embodiments is preferably shaped from the material of the lamp bulb. This simplifies production and mounting for the lamp according to various embodiments. In various embodiments, during the mounting of the lamp bulb on the base, at the same time the optical waveguide is also mounted and brought to the correct position and alignment with respect to the at least one semiconductor light source.

The base of the lamp according to various embodiments may have a reference plane with respect to which the spatial position and alignment of the first end of the optical waveguide are adjusted. The reference plane is a fictitious plane which is arranged perpendicularly to the longitudinal axis of the lamp and the position of which is defined for example by locking knobs on the base. By way of example, the first end of the optical waveguide of the lamp according to various embodiments can be positioned at the so-called luminous center of a comparable incandescent lamp that is replaced by the lamp according to various embodiments in order to generate a light distribution comparable with the light distribution of a corresponding incandescent lamp. In various embodiments, the first end of the optical waveguide of the lamp according to various embodiments is arranged at a distance E from the reference plane which corresponds to the distance between the incandescent filament and the reference plane in the case of a comparable incandescent lamp. This distance in the case of the comparable incandescent lamp with a standardized base in accordance with ECE Standard regulation No. 37 is also designated as e-dimension.

In various embodiments, components of an operating device for the at least one semiconductor light source are arranged in the base of the lamp according to various embodiments. As a result, the lamp according to various embodiments is fully compatible and interchangeable with an incandescent lamp equipped with the same standardized base. In various embodiments, the lamp does not require an external ballast for its operation, but rather can be operated directly from the power supply system voltage, for example from the on-board power supply system voltage of a motor vehicle.

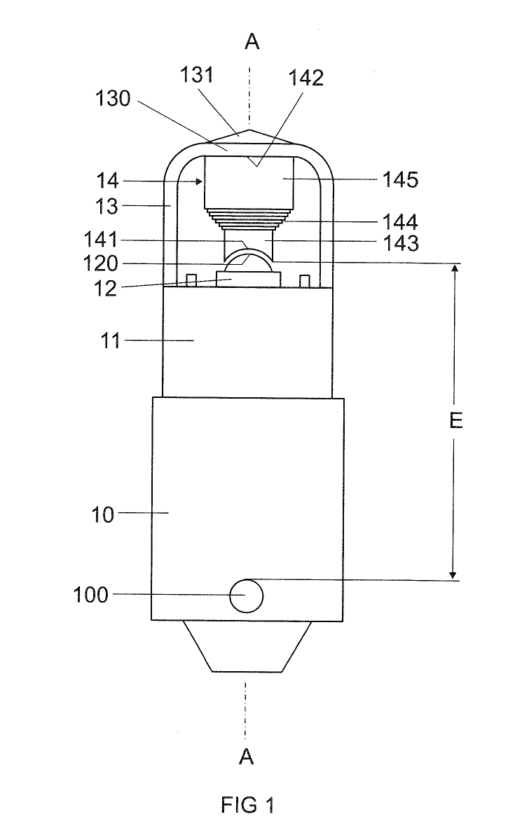

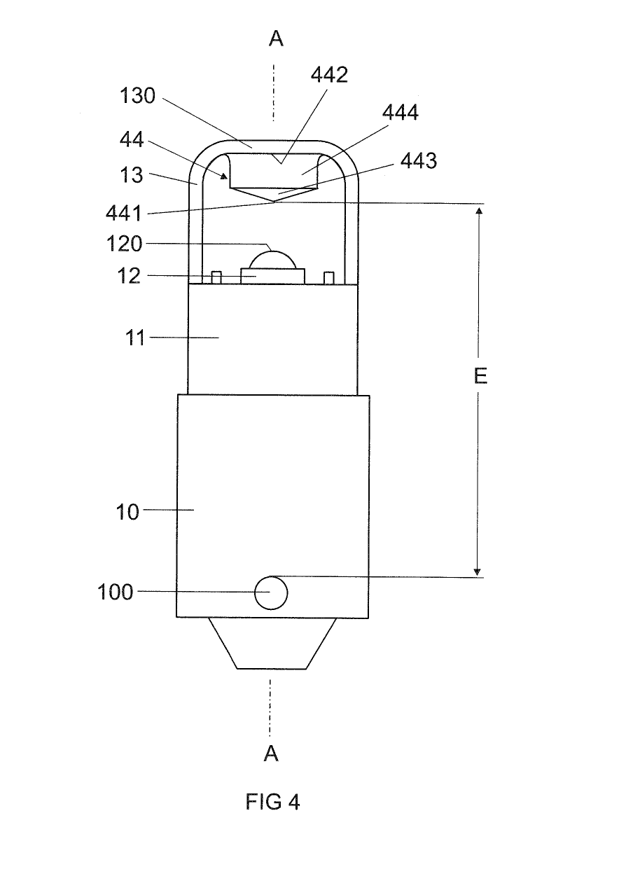

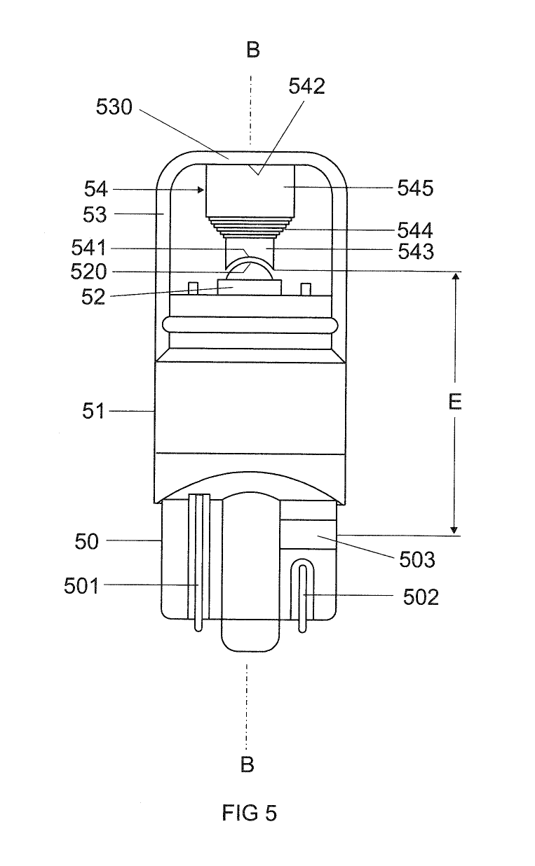

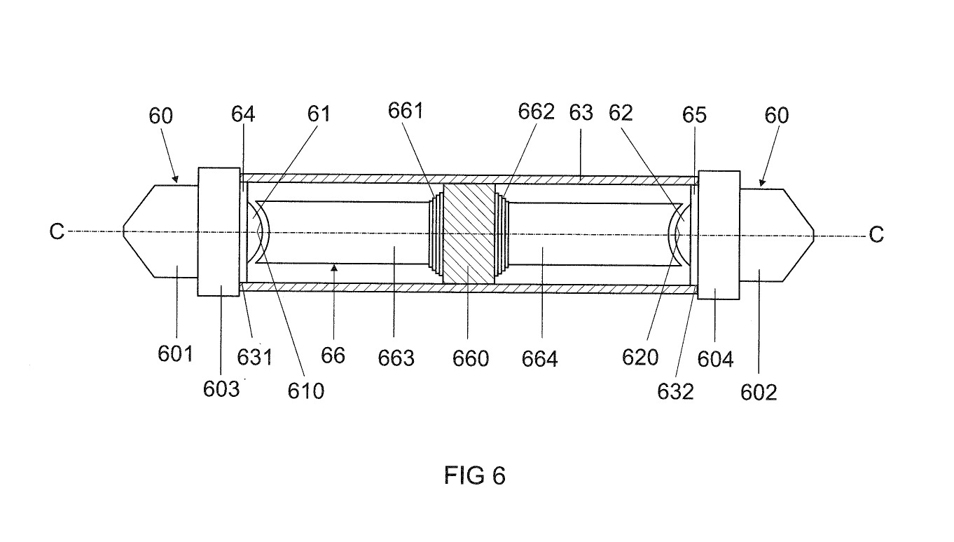

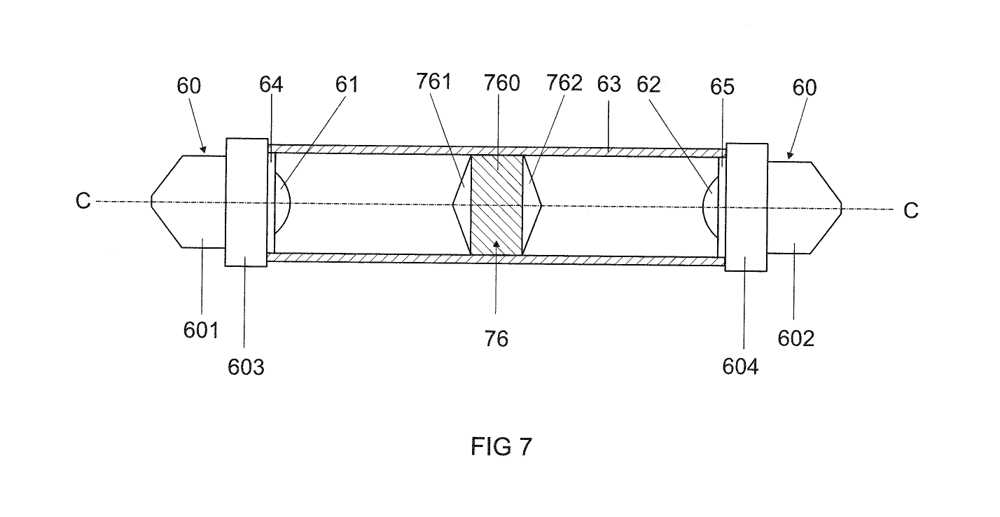

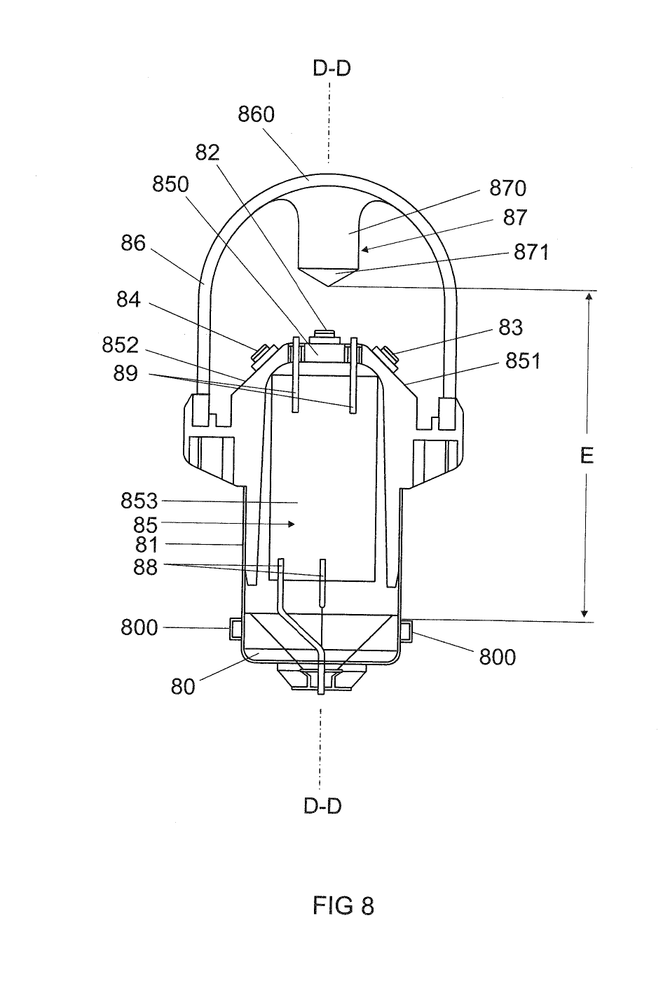

The lamps in accordance with the first three embodiments of various embodiments as depicted in FIG. 1 to FIG. 3 are compatible with a standardized vehicle incandescent lamp of ECE category T4W, which is used for example for license plate lighting or in side position lights or for lighting in the interior of a vehicle. The lamps in accordance with the first three embodiments of various embodiments have the same base as the abovementioned vehicle incandescent lamp, but, instead of the incandescent filament, are equipped in each case with a light-emitting diode that emits white light as light source. The lamps in accordance with the first three embodiments in each case have a base having the designation BA9s. The lamp in accordance with the fourth embodiment of various embodiments as illustrated schematically in FIG. 4 is compatible with a standardized vehicle incandescent lamp of ECE category R5W. The lamp in accordance with the fourth embodiment of various embodiments has the same base as the abovementioned vehicle incandescent lamp of ECE category R5W, e.g. a base having the designation BA15s, but, instead of the incandescent filament, is equipped with a light-emitting diode that emits white light as light source. The lamp in accordance with the fifth embodiment of various embodiments as illustrated schematically in FIG. 5 is compatible with a standardized vehicle incandescent lamp of category W5W, which is used for example as travel direction indicator or brake light, fog light or reversing light or for lighting in the interior of a vehicle. The lamp in accordance with the fifth embodiment of various embodiments has the same base as the abovementioned vehicle incandescent lamp of ECE category W5W, e.g. a base having the designation W2.1×9.5d, but, instead of the incandescent filament, is equipped with a light-emitting diode that emits white light as light source. The lamps in accordance with the sixth and seventh embodiments of various embodiments as depicted in FIG. 6 and FIG. 7 are in each case compatible with a vehicle incandescent lamp of ECE category C5W. These lamps are in each case equipped with two light-emitting diodes that emit white light as light sources and have the same base, namely a base having the designation SV8.5-8, as the abovementioned vehicle incandescent lamp. The lamp in accordance with the eighth embodiment of various embodiments as illustrated schematically in FIG. 8 is compatible with an incandescent lamp of ECE category P21/5W, which is used as a combined rear light and brake light in a vehicle. The lamp in accordance with the eighth embodiment of various embodiments has the same base, namely a base having the designation BAY15d, but, instead of the two incandescent filaments, is equipped with three light-emitting diodes that emit red light as light sources.

The lamp in accordance with the first embodiment of various embodiments as depicted in FIG. 1 has a standardized Ba9s base 10, a hollow-cylindrical heat sink 11 composed of copper, a light-emitting diode 12 mounted on a mounting circuit board having a T-shaped profile, and a lamp bulb 13 composed of transparent plastic. The Ba9s base is a bayonet base having two diametrically arranged locking knobs 100 on its cylindrical base sleeve. The electrical connections of the lamp are formed by a central contact arranged at the end side of the base 10 facing away from the lamp bulb 13, and by the lateral surface of the cylindrical base sleeve of the base 10. The light-emitting diode 12 is arranged on a section of the mounting circuit board that is aligned perpendicularly with respect to the longitudinal axis of the lamp. Moreover, components of an operating device for the light-emitting diode 12 are mounted on the mounting circuit board. The construction and the spatial arrangement of the mounting circuit board with regard to the heat sink 11 and the base 10 are disclosed in the utility model specification DE 20 2011 100 723 U1 cited above. The lamp bulb 13 is fixed by means of a press-fit on the end side of the heat sink 11 facing away from the base 10. The lamp bulb 13 is closed by a dome 130 at its end facing away from the base 10. In the region of the lamp bulb dome 130, the outer surface of the lamp bulb 13 has a conical curvature 131 outward. The lamp additionally has an optical waveguide 14, which is integrally molded onto the inner surface of the lamp bulb 13 in the region of the lamp bulb dome 130 and extends in the direction of the light-emitting diode 12.

The optical waveguide 14 has a first end 141, which is arranged at a small distance from the light-emitting surface 120 of the light-emitting diode 12 and the form of which is adapted to the form of the light-emitting surface 120 of the light-emitting diode 12 or to the light-emitting surface of a primary optical unit disposed downstream of the light-emitting diode 12 and connected to the light-emitting diode 12. A second end 142 of the optical waveguide 14 is integrally molded onto the inner side of the lamp bulb 13 in the region of the dome 130. The optical waveguide 14 has, proceeding from its first end 141, a first cylindrical optical waveguide section 143, which is connected to a second cylindrical optical waveguide section 145 via a truncated-cone-shaped optical waveguide section 144. The second cylindrical optical waveguide section 145 is connected to the lamp bulb 13 in the region of the dome 130 and has a larger diameter than the first cylindrical optical waveguide section 143. The lateral surface of the truncated-cone-shaped optical waveguide section 144 is provided with a staircase-like surface structure having a light-scattering effect, such that light is coupled out from the optical waveguide 14 in the region of the truncated-cone-shaped optical waveguide section 144 on account of the light-scattering effect of the staircase-like surface structure. The lateral surfaces of the two cylindrical optical waveguide sections 143, 145 are embodied in a totally reflecting fashion, for example by means of an aluminum coating, such that no light can emerge from said lateral surfaces. Part of the light emitted by the light-emitting diode 12 emerges from the lateral surface of the truncated-cone-shaped optical waveguide section 144 and illuminates the sections of the lamp bulb 13 that are arranged outside the dome 130, while the remaining light is guided to the dome 130 of the lamp bulb 13 and emerges from the lamp bulb dome 130 in the region of the conical curvature 131. The conical curvature 131 of the dome 130 ensures that light emerging from the dome 130 is emitted not only in the direction of the longitudinal axis A-A of the lamp but also in other directions. The light-emitting diode 12 and the optical waveguide 14 are arranged in the longitudinal axis A-A of the lamp. The optical waveguide 14 is embodied as rotationally symmetrical with respect to the longitudinal axis A-A. The first end 141 of the optical waveguide 14 is arranged at a distance E of 15 mm from a fictitious plane, also called reference plane, which runs perpendicular to the longitudinal axis A-A of the lamp and touches the locking knobs 100 at the side thereof facing the lamp bulb 13. The distance E corresponds to the e-dimension of an incandescent lamp of ECE category T4W in accordance with ECE Regulation No. 37.

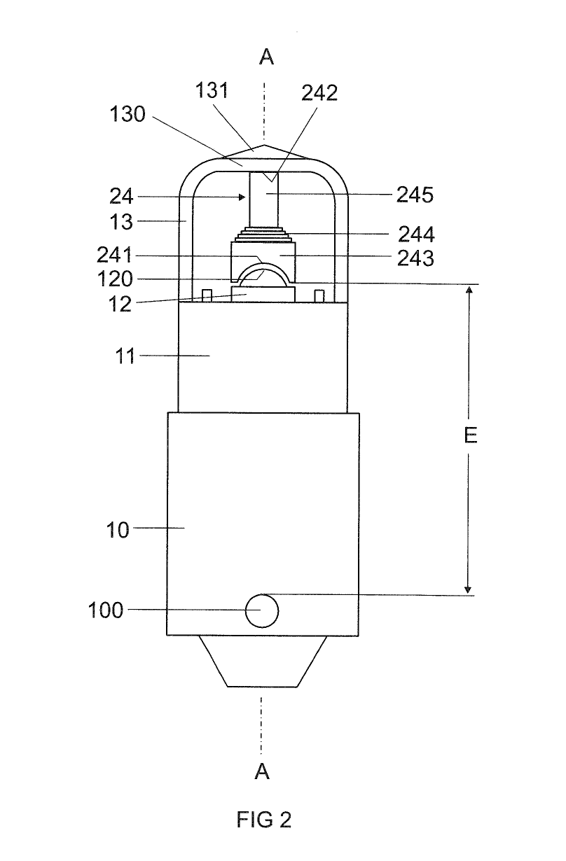

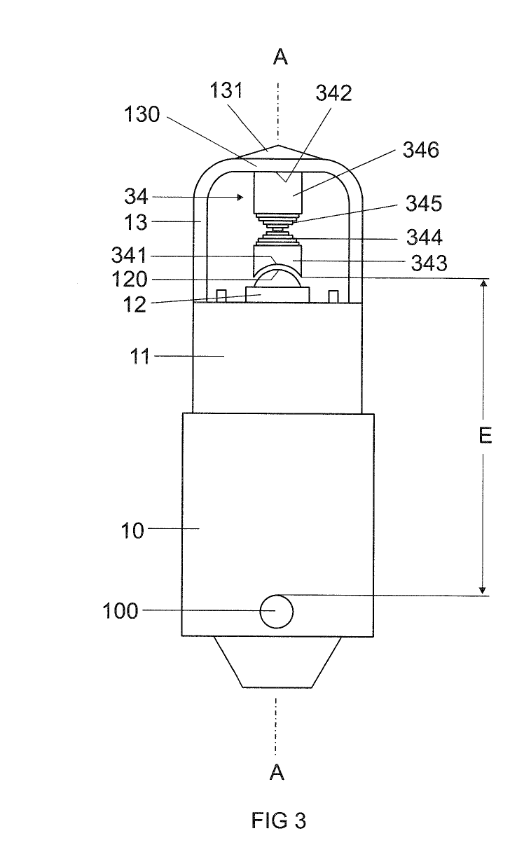

The lamps in accordance with embodiments two and three as depicted in FIG. 2 and FIG. 3 differ from the lamp in accordance with the first embodiment of various embodiments only in their optical waveguides 24 and 34, respectively. In all other details, the lamps in accordance with embodiments two and three correspond to the lamp in accordance with the first embodiment of various embodiments. The lamp in accordance with the fourth embodiment of various embodiments as depicted in FIG. 4 differs from the lamp in accordance with the first embodiment of various embodiments only in its optical waveguide 44 and its base. The lamp in accordance with the fourth embodiment of various embodiments has a bayonet base having the designation BA15s. The bayonet base BA15s differs from the bayonet base BA9s of the lamp in accordance with the first embodiment of various embodiments only in its dimensions. Therefore, the same reference signs are used in FIGS. 1 to 4 for identical parts of the lamps and for the base. For the description of these parts, reference is made to the description of the lamp in accordance with the first embodiment of various embodiments.

The lamp in accordance with the second embodiment of various embodiments as depicted in FIG. 2 has an optical waveguide 24 having a first end 241, which is arranged at a small distance from the light-emitting surface 120 of the light-emitting diode 12 and the form of which is adapted to the form of the light-emitting surface 120 of the light-emitting diode 12 or to the form of a primary optical unit disposed downstream of the light-emitting diode 12 and connected to the light-emitting diode 12. A second end 242 of the optical waveguide 24 is integrally molded onto the inner side of the lamp bulb 13 in the region of the dome 130. The optical waveguide 24 has, proceeding from its first end 241, a first cylindrical optical waveguide section 243, which is connected to a second cylindrical optical waveguide section 245 via a truncated-cone-shaped optical waveguide section 244. The second cylindrical optical waveguide section 245 is connected to the lamp bulb 13 in the region of the dome 130 and has a larger diameter than the first cylindrical optical waveguide section 243. The lateral surface of the truncated-cone-shaped optical waveguide section 244 is provided with a staircase-like surface structure having a light-scattering effect, such that light is coupled out from the optical waveguide 24 in the region of the truncated-cone-shaped optical waveguide section 244 on account of the light-scattering effect of the staircase-like surface structure. The lateral surfaces of the two cylindrical optical waveguide sections 243, 245 are embodied in a totally reflecting fashion, for example by means of an aluminum coating, such that no light can emerge from said lateral surfaces. Part of the light emitted by the light-emitting diode 12 emerges from the lateral surface of the truncated-cone-shaped optical waveguide section 244 and illuminates the sections of the lamp bulb 13 that are arranged outside the dome 130, while the remaining light is guided to the dome 130 of the lamp bulb 13 and emerges from the lamp bulb dome 130 in the region of the conical curvature 131. The conical curvature 131 of the dome 130 ensures that light emerging from the dome 130 is emitted not only in the direction of the longitudinal axis A-A of the lamp but also in other directions. The light-emitting diode 12 and the optical waveguide 24 are arranged in the longitudinal axis A-A of the lamp. The optical waveguide 24 is embodied as rotationally symmetrical with respect to the longitudinal axis A-A. The first end 241 of the optical waveguide 24 is arranged at a distance E of 15 mm from a fictitious plane which runs perpendicular to the longitudinal axis A-A of the lamp and touches the locking knobs 100 at the side thereof facing the lamp bulb 13. The distance E corresponds to the e-dimension of an incandescent lamp of ECE category T4W in accordance with ECE Regulation No. 37.

The lamp in accordance with the third embodiment of various embodiments as depicted in FIG. 3 has an optical waveguide 34 having a first end 341, which is arranged at a small distance from the light-emitting surface 120 of the light-emitting diode 12 and the form of which is adapted to the form of the light-emitting surface 120 of the light-emitting diode 12 or to the form of a primary optical unit disposed downstream of the light-emitting diode 12 and connected to the light-emitting diode 12. A second end 342 of the optical waveguide 34 is integrally molded onto the inner side of the lamp bulb 13 in the region of the dome 130. The optical waveguide 34 has, proceeding from its first end 341, a first cylindrical optical waveguide section 343, which is connected to a second cylindrical optical waveguide section 346 via two truncated-cone-shaped optical waveguide sections 344, 345. The second cylindrical optical waveguide section 346 is connected to the lamp bulb 13 in the region of the dome 130 and has a larger diameter than the first cylindrical optical waveguide section 343. The lateral surface of the two truncated-cone-shaped optical waveguide sections 344, 345 is provided in each case with a staircase-like surface structure having a light-scattering effect, such that light is coupled out from the optical waveguide 24 in the region of the truncated-cone-shaped optical waveguide sections 344, 345 on account of the light-scattering effect of the staircase-like surface structure. The two truncated-cone-shaped optical waveguide sections 344, 345 are oriented such that their truncated cone vertices touch one another. The lateral surfaces of the two optical waveguide sections 343, 346 are embodied in a totally reflecting fashion, such that no light can emerge from said lateral surfaces. Part of the light emitted by the light-emitting diode 12 emerges from the lateral surface of the truncated-cone-shaped optical waveguide sections 344, 345 and illuminates the sections of the lamp bulb 13 that are arranged outside the dome 130, while the remaining light is guided to the dome 130 of the lamp bulb 13 and emerges from the lamp bulb dome 130 in the region of the conical curvature 131. The conical curvature 131 of the dome 130 ensures that light emerging from the dome 130 is emitted not only in the direction of the longitudinal axis A-A of the lamp but also in other directions. The light-emitting diode 12 and the optical waveguide 34 are arranged in the longitudinal axis A-A of the lamp. The optical waveguide 34 is embodied as rotationally symmetrical with respect to the longitudinal axis A-A. The first end 241 of the optical waveguide 24 is arranged at a distance E of 15 mm from a fictitious plane which runs perpendicular to the longitudinal axis A-A of the lamp and touches the locking knobs 100 at the side thereof facing the lamp bulb 13. The distance E corresponds to the e-dimension of an incandescent lamp of ECE category T4W in accordance with ECE Regulation No. 37.

The lamp in accordance with the fourth embodiment of various embodiments as depicted in FIG. 4 has an optical waveguide 44 having a first end 441, which is arranged at a distance from the light-emitting surface 120 of the light-emitting diode 12 and is embodied in a conical fashion, wherein its cone vertex faces the light-emitting surface 120 of the light-emitting diode 12. A second end 442 of the optical waveguide 44 is integrally molded onto the inner side of the lamp bulb 13 in the region of the dome 130. The optical waveguide 44 has, proceeding from its first end 441, a conical optical waveguide section 443 and a cylindrical optical waveguide section 444. The cylindrical optical waveguide section 444 is connected to the lamp bulb 13 in the region of the dome 130. The lateral surface of the truncated-cone-shaped optical waveguide section 443 is roughened, such that it has a light-scattering effect. Part of the light emitted by the light-emitting diode 12 is scattered at the lateral surface of the conical optical waveguide section 443 and illuminates the sections of the lamp bulb 13 that are arranged outside the dome 130. The light coupled into the first end 441 of the optical waveguide 44 is guided by means of the cylindrical optical waveguide section 444 to the dome 130 of the lamp bulb 13 and emerges there from the lamp vessel 13. The lateral surface of the cylindrical optical waveguide section 444 is embodied in a totally reflecting fashion, for example by means of an aluminum coating, such that no light can emerge from the lateral surface. The light-emitting diode 12 and the optical waveguide 44 are arranged in the longitudinal axis A-A of the lamp. The optical waveguide 44 is embodied as rotationally symmetrical with respect to the longitudinal axis A-A. The first end 441 of the optical waveguide 44 is arranged at a distance E of 19 mm from a fictitious plane that runs perpendicular to the longitudinal axis A-A of the lamp and touches the locking knobs 100 at the side thereof facing the lamp bulb 13. The distance E corresponds to the e-dimension of an incandescent lamp of ECE category R5W in accordance with ECE Regulation No. 37.

The lamp in accordance with the fifth embodiment of various embodiments as depicted in FIG. 5 has a standardized W2.1×9.5d base 50 composed of plastic, a hollow-cylindrical heat sink 51 composed of copper, a light-emitting diode 52, which is mounted on a mounting circuit board having a T-shaped profile, and a lamp bulb 53 composed of transparent plastic. The electrical connections of the lamp are formed by two power supply wires 501, 502 projecting from the base 50, which extend parallel to the longitudinal axis B-B of the lamp and are bent by an angle of 180 degrees around that end of the base 50 which faces away from the lamp bulb 53.

The light-emitting diode 52 is arranged on a section of the mounting circuit board which is aligned perpendicularly with respect to the longitudinal axis B-B of the lamp. Moreover, components of an operating device for the light-emitting diode 52 are mounted on the mounting circuit board. The construction and the spatial arrangement of the mounting circuit board with regard to the heat sink 51 and the base 50 are disclosed in the utility model specification DE 20 2011 100 723 U1 cited above. The lamp bulb 53 is fixed by means of a press-fit on the end side of the heat sink 51 facing away from the base 50. The lamp bulb 53 is closed by a dome 530 at its end opposite the base 50. The lamp additionally has an optical waveguide 54, which is integrally molded onto the inner surface of the lamp bulb 53 in the region of the lamp bulb dome 530 and extends in the direction of the light-emitting diode 52.

The optical waveguide 54 has a first end 541, which is arranged at a small distance from the light-emitting surface 520 of the light-emitting diode 52 and the form of which is adapted to the form of the light-emitting surface 520 of the light-emitting diode 52 or to the form of a primary optical unit disposed downstream of the light-emitting diode 52 and connected to the light-emitting diode 52. A second end 542 of the optical waveguide 54 is integrally molded onto the inner side of the lamp bulb 53 in the region of the dome 530. The optical waveguide 54 has, proceeding from its first end 541, a first cylindrical optical waveguide section 543, which is connected to a second cylindrical optical waveguide section 545 via a truncated-cone-shaped optical waveguide section 544. The second cylindrical optical waveguide section 545 is connected to the lamp bulb 53 in the region of the dome 530 and has a larger diameter than the first cylindrical optical waveguide section 543. The lateral surface of the truncated-cone-shaped optical waveguide section 544 is provided with a staircase-like surface structure having a light-scattering effect, such that light is coupled out from the optical waveguide 54 in the region of the truncated-cone-shaped optical waveguide section 544 on account of the light-scattering effect of the staircase-like surface structure. The lateral surfaces of the two cylindrical optical waveguide sections 543, 545 are embodied in a totally reflecting fashion, for example by means of an aluminum coating, such that no light can emerge from said lateral surfaces. Part of the light emitted by the light-emitting diode 52 emerges from the lateral surface of the truncated-cone-shaped optical waveguide section 544 and illuminates the sections of the lamp bulb 53 that are arranged outside the dome 530, while the remaining light is guided to the dome 530 of the lamp bulb 53 and emerges there from the lamp bulb 53. The light-emitting diode 52 and the optical waveguide 54 are arranged in the longitudinal axis B-B of the lamp. The optical waveguide 54 is embodied as rotationally symmetrical with respect to the longitudinal axis B-B. The first end 541 of the optical waveguide 54 is arranged at a distance E of 12 7 mm from a fictitious plane, which is arranged perpendicularly to the longitudinal axis B-B of the lamp and runs centrally through a web 503 arranged perpendicularly to the longitudinal axis B-B of the lamp on the surface of the base 50. The distance E corresponds to the e-dimension of an incandescent lamp of ECE category W5W in accordance with ECE Regulation No. 37.

The lamp in accordance with the sixth embodiment of various embodiments as depicted in FIG. 6 has a standardized SV8.5-8 base 60, a tube-like, circular-cylindrical lamp vessel 63 composed of transparent plastic, and two light-emitting diodes 61, 62 arranged in the interior of the lamp vessel 63, one of said light-emitting diodes respectively being arranged at each end 631, 632 of the lamp vessel 63. The base 60 has two metallic base sleeves 601, 602, which close the ends 631, 632 of the lamp vessel 63 and are embodied as electrical contacts of the lamp. The light-emitting diodes 61, 62 are respectively arranged on a surface of a mounting circuit board 64, 65 that faces the interior of the lamp vessel 63 perpendicularly to the tube axis C-C of the lamp vessel 63. The components of the operating device for the two light-emitting diodes 61, 62 are arranged on a section of the mounting circuit board 64 that extends into the interior of the base sleeve 601. The second light-emitting diode 62 is electrically connected to the operating device or the base sleeve 601 by power supply wires (not depicted), that run on the inner wall of the lamp vessel 63 from contacts on the second mounting circuit board 65 to contacts on the first mounting circuit board 64 or to the first base sleeve 601. The base sleeves 601, 602 are respectively fixed to the ends 631, 632 of the lamp vessel 63 by means of a plastic ring 603, 604.

An optical waveguide 66 is arranged in the interior of the lamp vessel 63, said optical waveguide being embodied as rotationally symmetrical with respect to the tube axis C-C of the lamp vessel 63. The optical waveguide 66 has a central, cylindrical optical waveguide section 660, which is positioned centrally between the two light-emitting diodes 61, 62 and the lateral surface of which bears against the inner wall of the lamp bulb 63 and is connected to the lamp bulb 63. A respective truncated-cone-shaped optical waveguide section 661, 662 is integrally molded on the two end sides of the central, cylindrical optical waveguide section 660. The lateral surfaces of the truncated-cone-shaped optical waveguide sections 661, 662 each have a staircase-like surface structure. A first circular-cylindrical optical waveguide section 663 is integrally molded onto the truncated cone vertex of the first truncated-cone-shaped optical waveguide section 661, the diameter of said first circular-cylindrical optical waveguide section being smaller than the diameter of the central, cylindrical optical waveguide section 660 and said first circular-cylindrical optical waveguide section extending in the direction of the first light-emitting diode 61. That end of the first circular-cylindrical optical waveguide section 663 which faces the first light-emitting diode 61 is arranged at a small distance from the first light-emitting diode 61 and its form is adapted to the form of the light-emitting surface 610 of the first light-emitting diode 61. A second circular-cylindrical optical waveguide section 664 is integrally molded onto the truncated cone vertex of the second truncated-cone-shaped optical waveguide section 662, the diameter of said second circular-cylindrical optical waveguide section being smaller than the diameter of the central, cylindrical optical waveguide section 660 and said second circular-cylindrical optical waveguide section extending in the direction of the second light-emitting diode 62. That end of the second circular-cylindrical optical waveguide section 664 which faces the second light-emitting diode 62 is arranged at a small distance from the second light-emitting diode 62 and its form is adapted to the form of the light-emitting surface 620 of the second light-emitting diode 62. The lateral surfaces of the first 663 and second circular-cylindrical optical waveguide section 664 are embodied in a totally reflecting fashion, for example by means of an aluminum coating. The light coupled into the optical waveguide 66 can therefore leave the optical waveguide 66 only via the staircase-like surface—embodied in a light-scattering fashion—of the truncated-cone-shaped optical waveguide sections 661, 662 and via the lateral surface of the central cylindrical optical waveguide section 660 connected to the wall of the lamp bulb 63.

The outer dimensions of the lamp in accordance with the sixth embodiment of various embodiments as illustrated in FIG. 6 correspond to the outer dimensions of a standardized C5W incandescent lamp.

The lamp in accordance with the seventh embodiment as depicted in FIG. 7 differs from the lamp in accordance with the sixth embodiment of various embodiments only in its optical waveguide 76. The lamps in accordance with embodiments six and seven correspond in all other details. Therefore, the same reference signs are used in FIG. 6 and FIG. 7 for identical parts of the lamps. For the description of these parts, reference is made to the description of the lamp in accordance with the sixth embodiment of various embodiments.

The optical waveguide 76 is arranged centrally between the two light-emitting diodes 61, 62 in the interior of the lamp bulb 63 and is embodied as rotationally symmetrical with respect to the tube axis C-C of the lamp bulb 63. The optical waveguide 76 has a circular-cylindrical optical waveguide section 760 and two conical optical waveguide sections 761, 762, which are arranged respectively at one of the end sides of the circular-cylindrical optical waveguide section 760. The cone vertex of the first conical optical waveguide section 761 faces the first light-emitting diode 61 and the cone vertex of the second conical optical waveguide section 762 faces the second light-emitting diode 62. The lateral surfaces of the two conical optical waveguide sections 761, 762 are embodied in a light-scattering fashion, for example by means of a roughened surface. The lateral surface of the circular-cylindrical optical waveguide section 760 is connected to the lamp bulb 63 at the inner side. The light emitted by the light-emitting diodes 61, 62 is partly scattered in different directions at the lateral surface of the conical optical waveguide sections 761, 762 and partly coupled into the optical waveguide 63. The light coupled into the optical waveguide can leave the lamp via the lateral surface of the circular-cylindrical optical waveguide section 760 and the lamp bulb 63.

The lamp in accordance with the eighth embodiment of various embodiments as depicted in FIG. 8 has a standardized BAY15d base 80, a hollow-cylindrical heat sink 81 composed of copper, three light-emitting diodes 82, 83, 84, which emit red light during their operation and are concomitantly mounted on a mounting circuit board 85, and a lamp bulb 86 composed of transparent plastic. The BAY5d base 80 is a bayonet base having two diametrically arranged locking knobs 800 on its cylindrical base sleeve. The electrical connections of the lamp are formed by two contacts arranged on the end side of the base 80 facing away from the lamp bulb 86 and by the lateral surface of the cylindrical base sleeve of the base 80.

A first light-emitting diode 82 is arranged on a section 850 of the mounting circuit board 85 that is aligned perpendicularly with respect to the longitudinal axis D-D of the lamp. The first light-emitting diode 82 is arranged in the longitudinal axis D-D of the lamp or of the lamp bulb 86. It serves for example for generating the tail light in a motor vehicle. The other two light-emitting diodes 83, 84 are respectively arranged on a second and third section 851, 852 of the mounting circuit board 85. They serve for example for generating a brake light in a motor vehicle and can be switched on for example jointly with the first light-emitting diode 81 for this purpose. The second and third sections 851, 852 of the mounting circuit board 85 in each case form an angle of 45 degrees with the longitudinal axis D-D and are arranged at an angle of 45 degrees with respect to the first section 850 of the mounting circuit board. The arrangement of the three sections 850, 851, 852 of the mounting circuit board 85 and of the three light-emitting diodes 82, 83, 84 is symmetrical in relation to a rotation of the lamp about its longitudinal axis D-D by an angle of 180 degrees. Moreover, components of an operating device for the light-emitting diodes 82, 83, 84 are mounted on a fourth section 853 of the mounting circuit board 85, said fourth section extending into the heat sink 81. Electrical contact is made with the light-emitting diodes 82, 83, 84 and their operating device by means of electrical leads 88, 89 between the base 80 and the fourth section 853 of the mounting circuit board and between the sections 850, 851, 852, 853 of the mounting circuit board 85.

The lamp bulb 86 is fixed by means of a press-fit to the end side of the heat sink 81 facing away from the base 80 and is closed by a dome 860 at its end facing away from the base 80.

The lamp additionally has an optical waveguide 87, which is integrally molded onto the inner surface of the lamp bulb 86 in the region of the lamp bulb dome 860 and extends in the direction of the first light-emitting diode 82. The optical waveguide 87 is embodied as rotationally symmetrical with respect to the longitudinal axis D-D of the lamp. It has a circular-cylindrical optical waveguide section 870, which is connected to the inner side of the lamp bulb 86 in the region of the lamp bulb dome 860. The end 871 of the optical waveguide 87 facing the first light-emitting diode 82 is embodied in a conical fashion, wherein the cone vertex of the end 871 faces the first light-emitting diode 82. The lateral surface of the conical end 871 of the optical waveguide 87 is embodied in a light-scattering fashion, for example by means of a roughened surface. The light emitted by the light-emitting diodes 82, 83, 84 is partly scattered in different directions at the surface of the conical end 871 of the optical waveguide 87 and partly coupled into the optical waveguide 87 via the end 871. The light scattered at the conical end 871 impinges on the lamp bulb 87 outside the lamp bulb dome 860 and leaves the lamp bulb 87. The light coupled into the optical waveguide 87 is guided to the lamp bulb dome 860 and emitted via the lamp bulb dome 860. The cone vertex of the conical end 871 of the optical waveguide 87 is arranged at a distance E of 31.8 mm from the locking knobs 800 of the base 80. The upper side of the locking knobs 800 facing the lamp bulb 86 defines the position of a fictitious reference plane of the lamp arranged perpendicularly to the longitudinal axis D-D of the lamp. The distance E corresponds to the so-called e-dimension in accordance with ECE Regulation 37 for an incandescent lamp of ECE category P21/5W, with which the lamp in accordance with the eighth embodiment of various embodiments is compatible.

Various embodiments are not restricted to the embodiments explained in greater detail above. By way of example, the lamps according to various embodiments can also have other semiconductor light sources instead of light-emitting diodes. In various embodiments, the lamps according to various embodiments can have laser diodes which emit blue light and the light from which is proportionally converted into yellow light by means of phosphor, such that the lamps emit white light which is a mixture of converted yellow light and non-converted blue light. Moreover, light-emitting diodes or laser diodes that emit colored light can also be used as light sources, depending on the application. For example semiconductor light sources which emit orange-colored light for a flashing light luminaire or semiconductor light sources which emit red light for a brake light luminaire or tail light luminaire.

Furthermore, the optical waveguides of the lamps according to various embodiments can have a different form and arrangement. In various embodiments, the light-scattering effect of the optical waveguide sections embodied in a light-scattering fashion can be obtained in many different ways. The light-scattering effect can be achieved for example by means of a roughened surface of the light-scattering optical waveguide section or by means of light-scattering particles which are arranged on the surface or included in the interior of the optical waveguide, or by means of blisters included in the interior of the optical waveguide. Furthermore, the configuration of the lamp bulb and of the light-guiding elements need not be rotationally symmetrical. The interior of the lamp can be filled with air or an inert gas. The groove structure can be embodied in a terraced fashion or else have other suitable shapings, such as obliquely running grooves, grooves running in a curved fashion, zigzag patterns, etc.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A lamp, comprising:
a lamp bulb composed of light-transmissive material; and
at least one semiconductor light source arranged within the lamp bulb, and comprising a base, corresponding to a standardized incandescent lamp base;
wherein the lamp has at least one optical waveguide which is connected to the lamp bulb and extends in the direction of the at least one semiconductor light source.

2. The lamp of claim 1,
wherein the optical waveguide has an optical waveguide section arranged within the lamp bulb and embodied in a light-scattering fashion.

3. The lamp of claim 2,
wherein the optical waveguide section embodied in a light-scattering fashion comprises at least one truncated-cone-shaped section whose truncated cone lateral surface is provided with a groove structure or is embodied in a step-like or staircase-like fashion.

4. The lamp of claim 2,
wherein the optical waveguide section comprises light-scattering particles or cavities or a roughened surface.

5. The lamp of claim 1,
wherein a first end of the optical waveguide terminates in a positively locking manner with a light-emitting surface of the at least one semiconductor light source.

6. The lamp of claim 1,
wherein a first end of the optical waveguide faces the at least one semiconductor light source and is embodied in a conical or truncated-cone-shaped fashion.

7. The lamp of claim 6,
wherein the first end of the optical waveguide is embodied in a light-scattering fashion.

8. The lamp of claim 1,
wherein a second end of the optical waveguide is connected to the lamp bulb.

9. The lamp of claim 1,
wherein the lamp bulb has a conical surface structure in the region of connection to the optical waveguide.

10. The lamp of claim 1,
wherein the optical waveguide is shaped from the material of the lamp bulb.

11. The lamp of claim 1,
wherein the base has a reference plane with respect to which the spatial position and alignment of the first end of the optical waveguide are adjusted.

12. The lamp of claim 11,
wherein the first end of the optical waveguide is arranged at a distance from the reference plane which corresponds to the distance between the incandescent filament and the reference plane in the case of a compatible incandescent lamp.

13. The lamp of claim 1,
wherein components of an operating device for the at least one semiconductor light source are arranged in the base.
